(19) United States
(12) Patent Application Publication
(10) Pub. No.: US 2024/0213435 A1
(43) Pub. Date: Jun. 27, 2024

(54) CARBON NANOPARTICLE COATING METHOD

(71) Applicant: CARBON T&C Co., Ltd., Seoul (KR)

(72) Inventors: Gun Soo KIM, Seoul (KR); Ho Kyoung CHOI, Seoul (KR); Young Bin CHOI, Seoul (KR)

(73) Assignee: CARBON T&C Co., Ltd., Seoul (KR)

(21) Appl. No.: 18/394,457

(22) Filed: Dec. 22, 2023

(30) Foreign Application Priority Data
Dec. 26, 2022 (KR) 10-2022-0184336

(51) Int. Cl. H01M 4/04; H01M 4/62

(52) U.S. Cl. CPC H01M 4/0402; H01M 4/625; H01M 2004/028

(57) ABSTRACT

The present invention relates to a carbon nanoparticle coating method and, specifically, to a method by which carbon nanoparticles can be uniformly coated on the material to be coated.

### TECHNICAL FIELD

The present invention relates to a carbon nanoparticle coating method and, specifically, to a method by which carbon nanoparticles can be uniformly coated on the material to be coated.

### BACKGROUND ART

Recently, interest in energy storage technology has been increasing. Starting with the commercialization of carbon materials in leisure goods, the scope of their use is gradually expanding to comprise automobiles, aviation, IT, and new and renewable energy.

Nanocarbon materials are carbon-based nanomaterials that comprise carbon quantum dots or fullerenes, which are zero-dimensional structures of carbon, carbon nanoribbons and carbon nanotubes, which are one-dimensional structures, and graphene, which is a two-dimensional structure. Depending on the state of the material, nanocarbon materials may be broadly classified into carbon quantum dots, fullerene, carbon nanoribbons, carbon nanotubes, and graphene, and the manufacturing method thereof may be divided into top-down and bottom-up methods.

Nanocarbon materials have the properties of conductive carbon materials with high strength and thermal conductivity. In particular, when the size of the material is very small, such as carbon quantum dots, it exhibits quantum physical phenomena (e.g., various characteristics such as luminescence phenomenon, change in band gap, and down-conversion due to energy transition). These nanocarbon materials have excellent electrical, physical, chemical, and mechanical properties, and, thus, are emerging as new materials that overcome technological limitations in existing industrial fields.

Due to the trend of existing component materials being gradually replaced by carbon materials, private companies are showing increasing interest in carbon materials and are actively conducting research on ways to commercialize them in order to strengthen competitiveness. Accordingly, nanocarbon materials as conductive materials are highlighted as coating materials for electromagnetic wave shielding and for touch panels, and are rapidly spreading, replacing existing electrically conductive polymer composite materials.

The unique properties of CNTs have the potential to influence innovation in various application fields, and various product innovations using CNTs are expected to appear in these fields in the future. Due to the light weight and high strength characteristics of carbon fibers, its demand is increasing in civil engineering fields such as building materials, concrete structures, and earthquake-resistant reinforcement, and alternative energy fields such as compressed natural gas storage (CNG) tanks, wind power generation blades, centrifugal rotors, and fly wheels.

The unique physical properties of Graphene, another nanocarbon material, make it a material that is expected to innovate in various application fields, like CNT. Although CNT has a linear structure, Graphene has a plate-like structure, and, thus, its demand is increasing in various fields.

### SUMMARY OF INVENTION

### Technical Problem

In the conventional technology, in order to secure the conductivity of carbon nanoparticles, nanocarbon materials were added as an appendix in the positive electrode and negative electrode slurry manufacturing process. If a uniform conductive material slurry was not secured, battery performance deteriorated. By overcoming this and coating the slurry of carbon nanomaterials directly on the active material itself, more uniform conductivity may be secured, and the prepared battery may have a lower resistance element than the battery prepared using the conductive material slurry, thereby showing low sheet resistance and excellent lifespan characteristics.

### Solution to Problem

A method for coating carbon nanoparticles may comprise (1) mixing a dispersant, a first solvent, and a carbon nanomaterial to prepare a dispersion, (2) homogenizing carbon nanoparticles in the dispersion through a dispersion process, (3) stirring the dispersion with a material to be coated, and (4) adding a solution comprising an ionic compound to coat the carbon nanoparticles on the surface of the material to be coated.

The dispersant may be at least one selected from the group consisting of hydrogenated nitrile butadiene rubber, polyvinyl pyrrolidone, poly (acrylic acid), polyacrylonitrile, and polyacrylamide.

The first solvent may be at least one selected from the group consisting of water (H₂O), methanol, ethanol, n-methyl pyrrolidone, N,N-dimethylformamide (N,N-dimethylformamide), and dimethyl sulfoxide.

The carbon nanomaterial may be at least one selected from the group consisting of carbon nanotubes, carbon fiber, graphene and carbon black.

The ionic compound may be one selected from ionic compounds consisting of a salt of a Group 1 element and a halogen group element.

The material to be coated may be one or two or more selected from battery positive electrode materials of the group consisting of lithium cobalt manganese, lithium iron phosphate, lithium cobalt oxide, and nickel cobalt aluminum; battery negative electrode materials of the group consisting of silicon-carbon composite (Si-C Composite), silicon oxide (SiOx), silicon alloy, and metallurgical-grade silicon (MG-Si); heat dissipation materials of the group consisting of aluminum oxide (Al₂O₃), barium nitride (Ba₃N₂), and porous glass (glass bubble); and multilayer ceramic capacitors (MLCC) of the group consisting of barium titanate (BaTiO₃), nickel metal powder, and copper metal powder.

The method for coating carbon nanoparticles may further comprise adding a second solvent and stirring same with the material to be coated.

The second solvent may be at least one selected from the group consisting of methanol, ethanol, n-propanol, iso-propanol, n-butanol, iso-butanol, acetone, methyl ethyl ketone, methyl isobutyl ketone, ether acetate, butyl acetate, and amyl acetate.

The method for coating carbon nanoparticles may further comprise removing a filtrate from the material to be coated by using a filter press and aggregating the material to prepare a filter cake.

The method for coating carbon nanoparticles may further comprise drying the filter cake at 50° C. to 150° C.

### Advantageous Effects of Invention

According to the present invention, the addition of a solution consisting of a salt of a Group 1 element and a halogen group element can increase the adsorption power of carbon nanoparticles, obtain an active material uniformly coated with the carbon nanomaterial, ensuring conductivity, and improve conductivity to improve the movement of lithium ions.

In addition, the carbon-structured network layer can ensure electrical and chemical stability in the metal oxide, and can suppress irreversible reactions that may occur during charging and discharging and side reactions with the electrolyte.

When the carbon nanomaterial is coated on heat dissipation materials such as alumina (Al₂O₃) and boron nitride (BN), a high thermal conductivity can be obtained in addition to existing heat dissipation properties, thereby improving heat dissipation properties.

### BRIEF DESCRIPTION OF DRAWINGS

FIG. 1 is a flow chart of the carbon nanoparticle coating method according to an embodiment of the present invention.

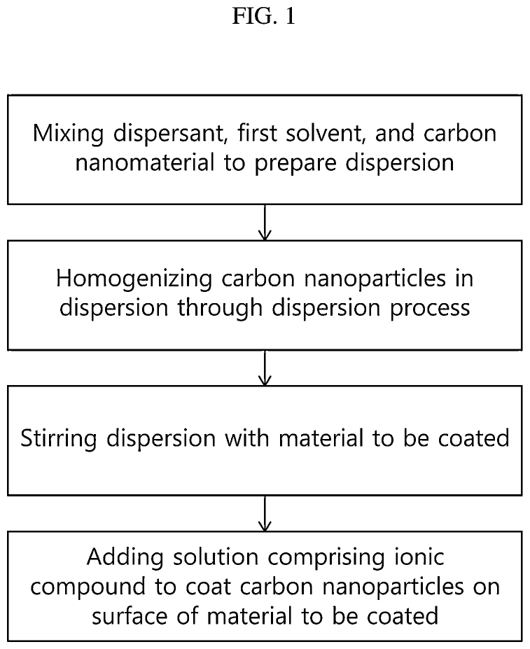

FIGS. 2A-2B are SEM images for confirming carbon nanotubes coated on the surface of NCM using the coating method of the present invention.

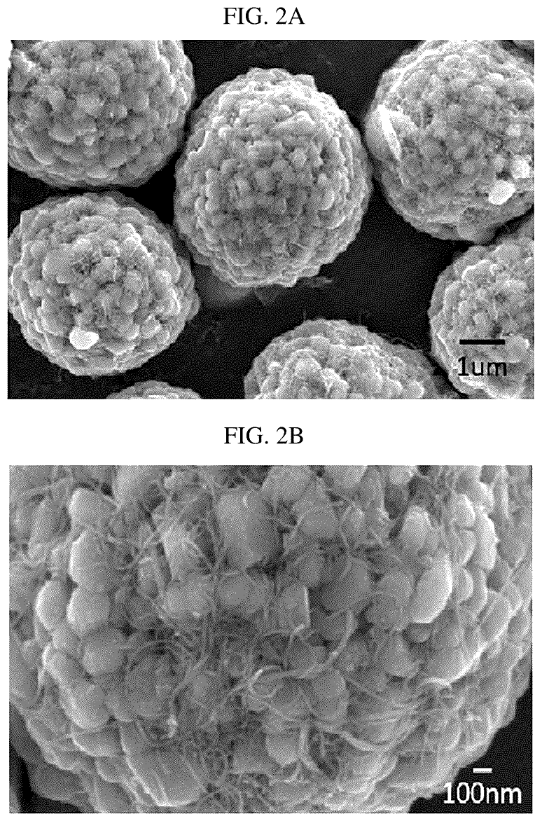

FIGS. 3A-3B are SEM images for confirming carbon nanotubes coated on the surface of Si using the coating method of the present invention.

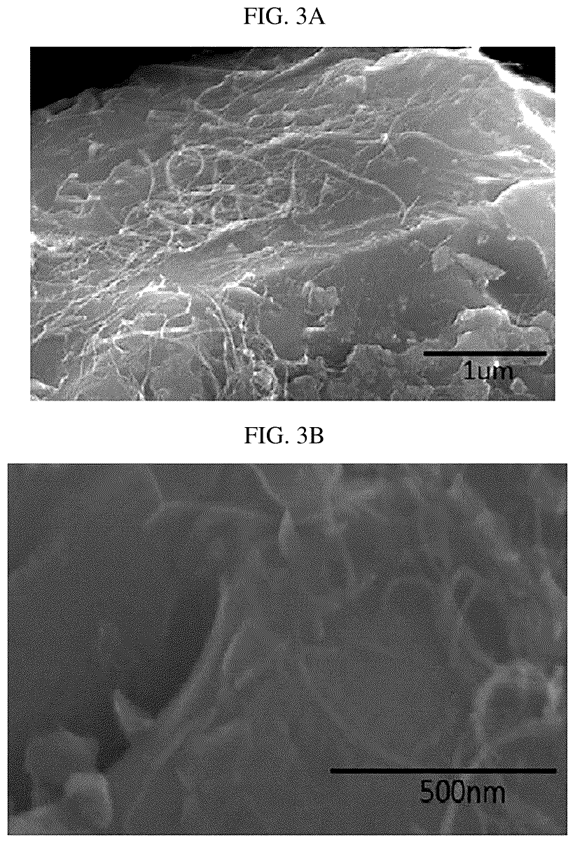

### MODE FOR INVENTION

A method for coating carbon nanoparticles may comprise (1) mixing a dispersant, a first solvent, and a carbon nanomaterial to prepare a dispersion, (2) homogenizing carbon nanoparticles in the dispersion through a dispersion process, (3) stirring the dispersion with a material to be coated, and (4) adding a solution comprising an ionic compound to coat the carbon nanoparticles on the surface of the material to be coated.

The step of (1) mixing a dispersant, a first solvent, and a carbon nanomaterial to prepare a dispersion may comprise a ball mill process.

Specifically, if the method comprises a wet ball mill process, the dispersant, first solvent, and carbon nanomaterial may be mixed and then subjected to a ball mill process at room temperature to prepare a dispersion. If the method comprises a dry ball mill process, carbon nanotube particles may be made from the carbon nanomaterial through a ball mill process, and then the dispersant and solvent may be mixed to prepare a dispersion.

The step of (1) mixing a dispersant, a first solvent, and a carbon nanomaterial to prepare a dispersion may comprise a homogenizer process.

The step (1) of mixing a dispersant, a first solvent, and a carbon nanomaterial to prepare a dispersion may comprise the ball mill process and the homogenizer process, but the present invention is not limited thereto.

The dispersant may be at least one selected from the group consisting of hydrogenated nitrile butadiene rubber, polyvinyl pyrrolidone, poly (acrylic acid), polyacrylonitrile, and polyacrylamide.

The first solvent may be at least one selected from the group consisting of water (H₂O), methanol, ethanol, n-methyl pyrrolidone, N,N-dimethylformamide (N,N-dimethylformamide), and dimethyl sulfoxide.

The carbon nanomaterial may be at least one selected from the group consisting of carbon nanotubes, carbon fiber, graphene and carbon black.

The dispersion process may be a step of homogenizing the carbon nanoparticles in the dispersion through a high pressure disperser or ultrasonic disperser.

According to one embodiment, the dispersion process may uniformly disperse carbon nanoparticles in the dispersion through high pressure dispersion.

According to one embodiment, the dispersion process may uniformly disperse carbon nanoparticles in the dispersion through ultrasonic dispersion.

The step of stirring the dispersion with the material to be coated may be performed at a speed of 500 to 5,000 rpm for uniform coating of carbon nanoparticles.

The ionic compound may be one selected from ionic compounds consisting of a salt of a Group 1 element and a halogen group element.

The addition of the ionic compound has the effect of increasing the coating and adsorption power of carbon nanoparticles in the process of coating and adsorbing the dispersion of carbon nanoparticles on the surface of the material to be coated.

The material to be coated may be a metal.

The material to be coated may be ceramic.

The material to be coated may be one or two or more selected from battery positive electrode materials, battery negative electrode materials, heat dissipation materials, and multilayer ceramic capacitors.

Specifically, the material to be coated may be one or two or more selected from battery positive electrode materials of the group consisting of lithium cobalt manganese, lithium iron phosphate, lithium cobalt oxide, and nickel cobalt aluminum; battery negative electrode materials of the group consisting of silicon-carbon composite (Si-C Composite), silicon oxide (SiOx), silicon alloy, and metallurgical-grade silicon (MG-Si); heat dissipation materials of the group consisting of aluminum oxide (Al₂O₃), barium nitride (Ba₃N₂), and porous glass (glass bubble); and multilayer ceramic capacitors (MLCC) of the group consisting of barium titanate (BaTiO₃), nickel metal powder, and copper metal powder.

A method for coating carbon nanoparticles may further comprise (1) mixing a dispersant, a first solvent, and a carbon nanomaterial to prepare a dispersion, (2) homogenizing carbon nanoparticles in the dispersion through a dispersion process, (3) stirring the dispersion with a material to be coated, (4) adding a solution comprising an ionic compound to coat the carbon nanoparticles on the surface of the material to be coated, and (5) adding a second solvent and stirring same with the material to be coated.

The second solvent is added in order to minimize aggregation which may occur in the coating material coated with carbon nanoparticles.

The second solvent may be at least one selected from the group consisting of methanol, ethanol, n-propanol, iso-propanol, n-butanol, iso-butanol, acetone, methyl ethyl ketone, methyl isobutyl ketone, ether acetate, butyl acetate, and amyl acetate.

The second solvent may be added in an amount of 50 to 500 parts by weight based on 100 parts by weight of the dispersion of carbon nanoparticles.

A method for coating carbon nanoparticles may further comprise (1) mixing a dispersant, a first solvent, and a carbon nanomaterial to prepare a dispersion, (2) homogenizing carbon nanoparticles in the dispersion through a dispersion process, (3) stirring the dispersion with a material to be coated, (4) adding a solution comprising an ionic compound to coat the carbon nanoparticles on the surface of the material to be coated, (5) adding a second solvent and stirring same with the material to be coated, and (6) removing a filtrate from the material to be coated by using a filter press and aggregating the material to prepare a filter cake.

The method may further comprise pulverizing the aggregate from which the filtrate has been removed by using a grinder or mixer.

The filter press may be a device equipped with a filter cloth and a membrane filter.

The filter cloth may have a pore size of 0.001 to 0.30 mm.

The filter press may be a device capable of producing a pressure of 1 to 10 bar.

A method for coating carbon nanoparticles may further comprise (1) mixing a dispersant, a first solvent, and a carbon nanomaterial to prepare a dispersion, (2) homogenizing carbon nanoparticles in the dispersion through a dispersion process, (3) stirring the dispersion with a material to be coated, (4) adding a solution comprising an ionic compound to coat the carbon nanoparticles on the surface of the material to be coated, (5) adding a second solvent and stirring same with the material to be coated, (6) removing a filtrate from the material to be coated by using a filter press and aggregating the material to prepare a filter cake, and (7) drying the filter cake at 50° C. to 150° C.

### Preparation Example 1. Preparation of Carbon Nanotube Dispersion

The step of adjusting the particle size of carbon nanotubes to match the particle size D50 of 5 μm of the material to be coated (e.g., NCM and Si) was performed through a ball mill or homogenizer process.

In the case of a wet ball mill, 1 g of carbon nanotubes was added to a solvent in which 1 g of hydrogenated nitrile rubber (HNBR) as a dispersant was dissolved in 98 μg of N-methylpyrrolidone (NMP), 80 g of 3-pi zirconia balls were added, and the mixture was rotated at 500 rpm at room temperature for 12 hours to prepare a carbon nanotube dispersion with a D50 of 5 μm. Zirconia balls were removed from the prepared carbon nanotube dispersion, and these were dispersed twice at a pressure of 1,500 MPa using a 100 μm diamond cell in a high-pressure disperser to prepare a carbon nanotube dispersion.

In the case of a dry ball mill, 7 kg of 3-pie zirconia balls were added, 150 g of carbon nanotubes were added, and the process was performed at 600 rpm for 30 minutes to prepare carbon nanotube particles with a D50 of Sum, which were placed in a solvent in which 1 g of dispersant (HNBR) was dissolved in 98 g of NMP, and dispersed twice at a pressure of 1,500 MPa using a 100 μm diamond cell in a high pressure disperser to prepare a carbon nanotube dispersion.

### Preparation Example 1. Preparation of Graphene Dispersion

The step of adjusting the particle size of graphene to match the particle size D50 of 5 μm of the material to be coated (e.g., NCM and Si) was performed through a ball mill or homogenizer process.

In the case of a wet ball mill, 1 g of graphene was added to a solvent in which 1 g of hydrogenated nitrile rubber (HNBR) as a dispersant was dissolved in 98 g of N-methylpyrrolidone (NMP), 80 g of 3-pi zirconia balls were added, and the mixture was rotated at 1,000 rpm at room temperature for 10 hours to prepare a graphene dispersion with a D50 of 5 μm. Zirconia balls were removed from the prepared carbon nanotube dispersion, and these were dispersed three times at a pressure of 1,000 MPa using a 200 μm diamond cell in a high-pressure disperser to prepare a graphene dispersion.

In the case of a dry ball mill, 7 kg of 3-pie zirconia balls were added, 100 g of graphene were added, and the process was performed at 700 rpm for 25 minutes to prepare graphene particles with a D50 of 5 um, which were placed in a solvent in which 1 g of dispersant (HNBR) was dissolved in 98 g of NMP, and dispersed three times at a pressure of 1,000 MPa using a 200 μm diamond cell in a high pressure disperser to prepare a carbon nanotube dispersion.

### Example 1. Carbon Nanotube Coating

25 g of the carbon nanotube dispersion prepared in Preparation Example 1 and 100 g of NCM as a material to be coated were homogenized and mixed. The mixture was stirred for 10 minutes at 1,000 to 3,000 rpm by using a homogenizer or powerful stirrer, and 0.05 g of LiCl was added to coat the carbon nanotubes on the surface of NCM.

Since aggregation occurs in materials coated with carbon nanotubes, 100 g of EtOH which has a large polarity difference from NMP and may relieve the aggregation was added and stirred. The mixture was then placed in a filter press to prepare a filter cake.

During the filter pressing, a filter cloth of 0.001 mm was used, and the pressure was set at 4 bar. The prepared filter cake was dried at 120° C., and the dried cake was pulverized to prepare a final product.

### Example 2

The procedure was the same as Example 1, except that 50 g of a carbon nanotube dispersion was used.

### Example 3

The procedure was the same as Example 1, except that 100 g of a carbon nanotube dispersion was used.

### Example 4. Graphene Coating

25 g of the graphene dispersion prepared in Preparation Example 1 and 100 g of NCM as a material to be coated were homogenized and mixed. The mixture was stirred for 10 minutes at 1, 000 to 3, 000 rpm by using a homogenizer or powerful stirrer, and 0.05 g of LiCl was added to coat the graphene on the surface of NCM.

Since aggregation occurs in materials coated with graphene, 100 g of EtOH which has a large polarity difference from NMP and may relieve the aggregation was added and stirred. The mixture was then placed in a filter press to prepare a filter cake.

During the filter pressing, a filter cloth of 0.001 mm was used, and the pressure was set at 4 bar. The prepared filter cake was dried at 120° C., and the dried cake was pulverized to prepare a final product.

### Example 5

The procedure was the same as Example 4, except that 50 g of a graphene dispersion was used.

### Example 6

The procedure was the same as Example 4, except that 100 g of a graphene dispersion was used.

### Comparative Example 1

The procedure was the same as Example 1, except that neither the carbon nanotube dispersion nor the graphene dispersion was used, and a bare NCM positive electrode active material was used.

### Comparative Example 2

The procedure was the same as Example 1, except that coating was performed without using a LiCl solution.

### Comparative Example 3

The procedure was the same as Example 4, except that coating was performed without using a LiCl solution.

### Example 7. Preparation of a Positive Electrode Slurry

A positive electrode slurry was prepared by using the NCM obtained in Examples 1 to 6 and Comparative Examples 1 to 3. The method is as follows.

PVDF as a binder was mixed with NMP as a solvent to form a first mixture. Afterwards, the first mixture was mixed with carbon black to form a second mixture. Afterwards, the second mixture was mixed with NCM as a positive electrode active material to prepare a positive electrode slurry. The solid content of the positive electrode slurry was 60% by weight. The weight ratio of the positive electrode active material, conductive material, and binder in the positive electrode slurry was 96:2:2.

### Example 8. Si Coating

25 g of the carbon nanotube dispersion prepared in Preparation Example 1 and 100 g of Si as a material to be coated were homogenized and mixed. The mixture was stirred for 10 minutes at 1,000 to 3,000 rpm by using a homogenizer or powerful stirrer, and 0.05 g of LiCl was added to coat the carbon nanotubes on the surface of Si.

### Example 9

The procedure was the same as Example 1, except that 50 g of a carbon nanotube dispersion was used.

### Example 10

25 g of the graphene dispersion prepared in Preparation Example 1 and 100 g of Si as a material to be coated were homogenized and mixed. The mixture was stirred for 10 minutes at 1, 000 to 3, 000 rpm by using a homogenizer or powerful stirrer, and 0.05 g of LiCl was added to coat the graphene on the surface of Si.

Since aggregation occurs in materials coated with graphene, 100 g of EtOH which has a large polarity difference from Si and may relieve the aggregation was added and stirred. The mixture was then placed in a filter press to prepare a filter cake.

During the filter pressing, a filter cloth of 0.001 mm was used, and the pressure was set at 4 bar. The prepared filter cake was dried at 120° C., and the dried cake was pulverized to prepare a final product.

### Example 11

The procedure was the same as Example 10, except that 50 g of a graphene dispersion was used.

### Comparative Example 4

The procedure was the same as Example 8, except that neither the carbon nanotube dispersion nor the graphene dispersion was used, and bare Si was used.

### Comparative Example 5

The procedure was the same as Example 8, except that coating was performed without using a LiCl solution.

### Comparative Example 6

The procedure was the same as Example 10, except that coating was performed without using a LiCl solution.

### Example 12. Preparation of a Negative Electrode Slurry

A negative electrode slurry was prepared by using the NCM obtained in Examples 8 to 11 and Comparative Examples 4 to 6. The method is as follows.

A conductive material dispersion, carbon black, and Si as a silicon-based active material were mixed to form a first mixture. Afterwards, the first mixture was mixed with artificial graphite to form a second mixture. Afterwards, the second mixture was mixed with water as a solvent and CMC as a thickener to form a third mixture. Afterwards, the third mixture was mixed with styrene butadiene rubber (SBR) as a binder to prepare a negative electrode slurry. In the negative electrode slurry, the weight ratio of the negative electrode active material (with the weight ratio of artificial graphite:Si=86.39:9.61), conductive material (with the weight ratio of carbon black:single-walled carbon nanotube=0.96:0.04), thickener, and binder was 96:1:1.7:1.3.

### Experimental Example 1. Measurement of Sheet Resistance

The positive electrode slurry prepared in Example 7 was coated on an aluminum foil by using a 150 μm blade. The coated aluminum foil was dried at 120° C. for 30 minutes to prepare measurement specimens. The surface resistance of each measurement specimen was measured by using a surface measuring instrument (ST-4).

Table 1 below shows the surface resistance measurements of the positive electrode slurry prepared using the NCM obtained in Examples 1 to 6 and Comparative Examples 1 to 3.

TABLE 1

| | Comparative | Comparative | Comparative | Example | Example | Example | Example | Example | Example |
|---|---|---|---|---|---|---|---|---|---|
| | example 1 | example 2 | example 3 | 1 | 2 | 3 | 4 | 5 | 6 |
| Surface | 10\hat{ }3.7 | 10\hat{ }3.6 | 10\hat{ }3.6 | 10\hat{ }3.1 | 10\hat{ }2.8 | 10\hat{ }3.4 | 10\hat{ }3.3 | 10\hat{ }3.1 | 10\hat{ }3.5 |
| resistance | | | | | | | | | |

Unit: Surface resistance (Ω/□)

### Experimental Example 2. Evaluation of Discharge Capacity According to Discharge C-Rate

The positive electrode slurry prepared in Example 7 was applied to an aluminum current collector with a thickness of 20 μm, and vacuum dried at 120° C. for 10 hours to prepare a positive electrode. The loading amount of the prepared positive electrode was 8.8 mg/cm², and the total thickness was 54 um. A lithium (Li) metal thin film cut into a circular shape of 1.76 cm² was used as the negative electrode.

A porous polyethylene separator was interposed between the positive electrode and negative electrode, and an electrolyte (with the ratio of ethylene carbonate (EC) dimethyl carbonate (DMC): diethyl carbonate (DEC) of 3:4:3 (volume ratio)) and lithium hexafluorophosphate (1 mole of LiPF₆) were injected to prepare a half cell in the form of a CR-2032 coin cell.

0.5C charge/0.5C discharge was performed 5 times within the voltage range of 3.0V to 4.25V, the charge C-rate was fixed at 0.5C, and the discharge C-rate was increased to measure the discharge capacity. The discharge C-rate was increased to 5C and then decreased to 0.5C to evaluate the discharge efficiency of the positive electrode.

Table 2 below shows the results of measuring discharge capacity using the positive electrode slurry prepared using the NCM obtained in Comparative Examples 1 to 3 and Examples 1 to 6.

TABLE 2

| | Comparative | Comparative | Comparative | Example | Example | Example | Example | Example | Example |
|---|---|---|---|---|---|---|---|---|---|
| | example 1 | example 2 | example 3 | 1 | 2 | 3 | 4 | 5 | 6 |
| 0.5 C | 99.50% | 99.50% | 99.40% | 99.80% | 99.90% | 99.70% | 99.70% | 99.80% | 99.60% |
| 1.0 C | 84.30% | 88.20% | 85.20% | 93.20% | 98.90% | 91.90% | 92.60% | 94.40% | 90.80% |
| 2.0 C | 52.50% | 60.40% | 58.50% | 90.60% | 95.40% | 80.10% | 88.10% | 92.20% | 78.20% |
| 5.0 C | 18.60% | 36.60% | 32.50% | 78.50% | 84.60% | 66.20% | 72.40% | 80.40% | 60.70% |
| 0.5 C | 95.40% | 95.50% | 95.50% | 99.70% | 99.90% | 99.70% | 99.60% | 99.80% | 98.90% |

Referring to Table 2, when the carbon nanomaterial was not coated on NCM as an active material (Comparative Example 1), conductivity was secured by carbon black such that the NCM had high sheet resistance, and, as a result of the actual coin cell test, the performance deteriorated at a high C-rate. When a salt of a halogen element was not used (Comparative Examples 2 and 3), the carbon nanomaterial to be coated on the active material were not uniformly adsorbed such that the sheet resistance value was not significantly different from Comparative Example 1, and, as a result of the C-rate, the prepared slurry showed slightly better efficiency than Comparative Example 1.

In addition, it was confirmed that, when coating is performed using a salt of a halogen element according to Examples 1 to 6, the battery resistance or C-rate characteristics of lithium ion secondary batteries could be improved by adjusting the ratio of the carbon nanomaterial and NCM active material.

### Experimental Example 3. Electrochemical Evaluation and Property Evaluation

The negative electrode slurry prepared in Example 12 was coated on a copper current collector and dried at 100° C. for 12 hours to prepare a negative electrode. A lithium metal thin film cut into a circle of 1.76 cm² was used as a positive electrode.

A porous polyethylene separator was placed between the positive electrode and negative electrode, and electrolyte (with the ratio of ethylene carbonate (EC):ethylmethyl carbonate (EMC) of 3:7 (volume ratio)), lithium hexafluorophosphate (1 mole of LiPF₆), and 1.0% by weight of vinylidene carbonate (VC) based on the weight of the electrolyte were injected to prepare a coin cell.

The cycle characteristics of batteries using Si obtained in Examples 8 to 10 and Comparative Examples 4 to 6 were evaluated, and the results according to formation were summarized, and the expansion rate after life was indicated.

Specifically, charging/discharging was performed for each battery under the following conditions.

1 to 2 cycles: Charging at 0.1C constant current, and discharging at 0.1C constant current up to 1.5V.

3 to 50 cycles: Chargingat 0.5C constant current, and discharging at 0.5C constant current up to 1.0V.

Table 3 below shows the results of evaluating the lifespan characteristics of the negative electrode slurries prepared in Comparative Examples 4 to 6 and Examples 8 to 11.

TABLE 3

| | Comparative | Comparative | Comparative | | | | |
|---|---|---|---|---|---|---|---|
| Cycle (s) | example 4 | example 5 | example 6 | Example 8 | Example 9 | Example 10 | Example 11 |
| 1 | 100% | 100% | 100% | 100% | 100% | 100% | 100% |
| 10 | 89.8% | 90.2% | 90.0% | 95.9% | 97.5% | 103.2% | 101.9% |
| 20 | 81.5% | 83.5% | 83.4% | 93.8% | 95.6% | 91.6% | 92.5% |
| 30 | 78.6% | 79.4% | 78.8% | 91.5% | 94.3% | 86.5% | 87.4% |
| 40 | 75.5% | 76.6% | 75.8% | 89.2% | 92.6% | 80.1% | 82.6% |
| 50 | 71.5% | 74.2% | 73.5% | 85.6% | 88.8% | 78.6% | 80.2% |

Table 4 below shows the results of evaluating the loading, average density, average capacity, average efficiency, and expansion rate after life of the negative electrode slurries prepared by Examples 4 to 6 and Examples 8 to 11.

TABLE 4

| | Comparative | Comparative | Comparative | Example | Example | Example | Example |
|---|---|---|---|---|---|---|---|
| | example 4 | example 5 | example 6 | 8 | 9 | 10 | 11 |
| Loading (mg/cm²) | 7.4 | 7.5 | 7.4 | 7.4 | 7.5 | 7.5 | 7.4 |
| Average density | 1.52 | 1.52 | 1.53 | 1.52 | 1.53 | 1.52 | 1.53 |
| (g/cc) | | | | | | | |
| Average | 435 | 438 | 436 | 439 | 441 | 435 | 439 |
| capacity (mAh/g) | | | | | | | |
| Average | 88.9 | 89.2 | 89.1 | 90.0 | 90.4 | 90.0 | 90.2 |
| efficiency | | | | | | | |
| (D/C %) | | | | | | | |
| Expansion rate | 58 | 53 | 56 | 49 | 43 | 54 | 48 |
| after life (%) | | | | | | | |

Referring to Table 4, when a salt of a halogen element was not used (Comparative Examples 5 to 6), the lifespan characteristics of bare Si (Comparative Example 4) decreased, and the expansion rate after evaluation of lifespan characteristics was high.

The Si negative electrode active material coated with 0.25% of carbon nanomaterial (Examples 8 to 10) had slightly improved lifespan characteristics but showed a high expansion rate, and the Si alloy negative electrode active material coated with 0.5% of carbon nanomaterial (Examples 9 to 11) showed high lifespan characteristics and a lower expansion rate after evaluation of lifespan characteristics.

It is confirmed that the lifespan characteristics of lithium ion secondary batteries can be improved in the negative electrode by using a salt of a halogen element and adjusting the content of a carbon nanomaterial.

1. A carbon nanoparticle coating method comprising:
(1) mixing a dispersant, a first solvent, and a carbon nanomaterial to prepare a dispersion;
(2) homogenizing carbon nanoparticles in the dispersion through a dispersion process;
(3) stirring the dispersion with a material to be coated; and
(4) adding a solution comprising an ionic compound to coat the carbon nanoparticles on the surface of the material to be coated.

2. The carbon nanoparticle coating method according to claim 1, wherein the dispersant is at least one selected from the group consisting of hydrogenated nitrile butadiene rubber, polyvinyl pyrrolidone, poly (acrylic acid), polyacrylonitrile, and polyacrylamide.

3. The carbon nanoparticle coating method according to claim 1, wherein the first solvent is at least one selected from the group consisting of water (H₂O), methanol, ethanol, n-methyl pyrrolidone, N,N-dimethylformamide (N,N-dimethylformamide), and dimethyl sulfoxide.

4. The carbon nanoparticle coating method according to claim 1, wherein the carbon nanomaterial is at least one selected from the group consisting of carbon nanotubes, carbon fiber, graphene and carbon black.

5. The carbon nanoparticle coating method according to claim 1, wherein the ionic compound is one selected from ionic compounds consisting of a salt of a Group 1 element and a halogen group element.

6. The carbon nanoparticle coating method according to claim 1, wherein the material to be coated is at least one or selected from battery positive electrode materials of the group consisting of lithium cobalt manganese, lithium iron phosphate, lithium cobalt oxide, and nickel cobalt aluminum; battery negative electrode materials of the group consisting of silicon-carbon composite (Si-C Composite), silicon oxide (SiOx), silicon alloy, and metallurgical-grade silicon (MG-Si); heat dissipation materials of the group consisting of aluminum oxide (Al₂O₃), barium nitride (Ba₃N₂), and porous glass (glass bubble); and multilayer ceramic capacitors (MLCC) of the group consisting of barium titanate (BaTiO₃), nickel metal powder, and copper metal powder.

7. The carbon nanoparticle coating method according to claim 1, wherein the method further comprises the step of (5) adding a second solvent and stirring same with the material to be coated.

8. The carbon nanoparticle coating method according to claim 7, wherein the second solvent is at least one selected from the group consisting of methanol, ethanol, n-propanol, iso-propanol, n-butanol, iso-butanol, acetone, methyl ethyl ketone, methyl isobutyl ketone, ether acetate, butyl acetate, and amyl acetate.

9. The carbon nanoparticle coating method according to claim 7, wherein the method further comprises the step of (6) removing a filtrate from the material to be coated by using a filter press and aggregating the material to prepare a filter cake.

10. The carbon nanoparticle coating method according to claim 9, wherein the method further comprises the step of (7) drying the filter cake at 50° C. to 150° C.
